(19) United States
(12) Patent Application Publication
(10) Pub. No.: US 2025/0250469 A1
(43) Pub. Date: Aug. 7, 2025

(54) STRAIGHT EDGE CUT EASY HAND TEARING TAPES

(71) Applicants: LANCE KIETH JAMES, Montclair, NJ (US); HOWE CHAN, Taichung City (TW); FAR EASTERN STANDARD PACKAGING CO., LTD., Taichung City (TW)

(72) Inventor: LANCE KIETH JAMES, Montclair, NJ (US)

(21) Appl. No.: 18/435,735

(22) Filed: Feb. 7, 2024

(51) Int. Cl. C09J 7/40

(52) U.S. Cl. CPC C09J 7/405; C09J 2301/18

(57) ABSTRACT

Straight edge cut easy hand tearing tapes, each straight edge cut easy hand tearing tape contains: a cylinder and a tape strip, and the tape strip includes a tape body and an adhesion layer. The cylinder includes a predetermined width. The tape body flatly extends, and the tape body has a width for matching with the predetermined width of the cylinder, an internal face, and an external face opposite to the internal face. The adhesion layer has an equal thickness defined on the surface of the internal face. The tape strip includes a predetermined length and a linearly spaced portion which is not a removal manner. The linearly spaced portion has a connection section and a separation section.

### TECHNICAL FIELD

The present invention relates to tapes, and more particularly to straight edge cut easy hand tearing tapes.

### BACKGROUND

With the invention of tape, it has become a necessity in people's daily life or industrial production, because of its convenience and strong bonding properties. Generally speaking, most tapes are quite long. One side of the tape is sticky and the other side is not sticky and is rolled. When using the tape, it is torn off and adhered to an object. After being pulled out to a predetermined length, the tape is then cut with a tape stand or a knife. Although using a tape dispenser to cut off the tape is more convenient than cutting the tape with a knife, the tape used with the tape dispenser is bulky and heavy, which can easily cause injuries to the arms and shoulders of workers who use it all day and for a long time.

With reference to FIGS. 1 and 2, a conventional easy hand tearing tape contains a cylinder 80 and a tape strip 90 made of frangibility material, such as OPP and flatly extending outward. The tape strip 90 includes an adhesive area 91 on which adhesive glue is coated, multiple micro-jags 92 defined on two long sides of the tape strip 90 (as shown in FIG. 2). When the tape strip 90 is pulled to a desired length, the tape strip is torn off by pulling the two long sides and by using the multiple micro-notches and the frangibility material, thus cutting the tape strip 90 directly. However, such a tape strip 90 is cut in any desired length and position, thus having insufficient strength and prevention, uneven torn cross-section, and poor aesthetic appearance, as illustrated in FIG. 2

Referring to FIG. 3, another conventional easy hand tearing tape contains a cylinder 80A and a tape strip 90A, wherein the tape strip 90A includes multiple successive apertures 91A defined in a fixed distance and a removal manner. When pulling the tape strip 90A to a desired length, a long side of the multiple apertures 91A of the tape strip 90A is pulled and torn, and the tape strip 90A is torn off directly by pulling the multiple successive apertures 91A. Such a tearing operation will not use a tool, but an edge of the tape strip 90A is serrated because of the multiple successive apertures 91A. When tearing off the tape strip 90A, the tape strip 90A is cut from the serrated portion, so the tape strip 90A cannot be torn off directly and completely.

The present invention has arisen to mitigate and/or obviate the afore-described disadvantages.

### SUMMARY

The primary aspect of the present invention is to provide straight edge cut easy hand tearing tapes, each straight edge cut easy hand tearing tape contains a tape strip, a predetermined length and a linearly spaced portion which is not a removal manner so as to limit the length of the tape strip without using a tape dispenser or a knife, hence strength of the tape strip is maintained and the tape strip is applied conveniently and easily, and an aesthetics appearance and a flatness are achieved, after manually tearing the tape strip.

To obtain the above-mentioned aspect, straight edge cut easy hand tearing tapes provided by the present invention, each straight edge cut easy hand tearing tape contains: a cylinder and a tape strip, and the tape strip includes a tape body and an adhesion layer.

The cylinder is hollowly annular and includes a predetermined width.

The tape body flatly extends, and the tape body has a width for matching with the predetermined width of the cylinder, an internal face, and an external face opposite to the internal face.

The adhesion layer has an equal thickness defined on the surface of the internal face.

The tape strip includes a predetermined length and a linearly spaced portion which is not a removal manner, and the linearly spaced portion has a connection section and a separation section which are alternatively formed on the linearly spaced portion.

The tape strip is rolled by using the adhesion layer of the internal face of the tape body and is adhered to a peripheral wall of the cylinder, when the tape strip is rolled in at least one circle, the adhesion layer of the internal face is adhered on a release layer of the external face of the tape strip which is previously rolled, such that the tape strip is rolled spirally.

### BRIEF DESCRIPTION OF THE DRAWINGS

FIG. 1 is a perspective view of a conventional tape.

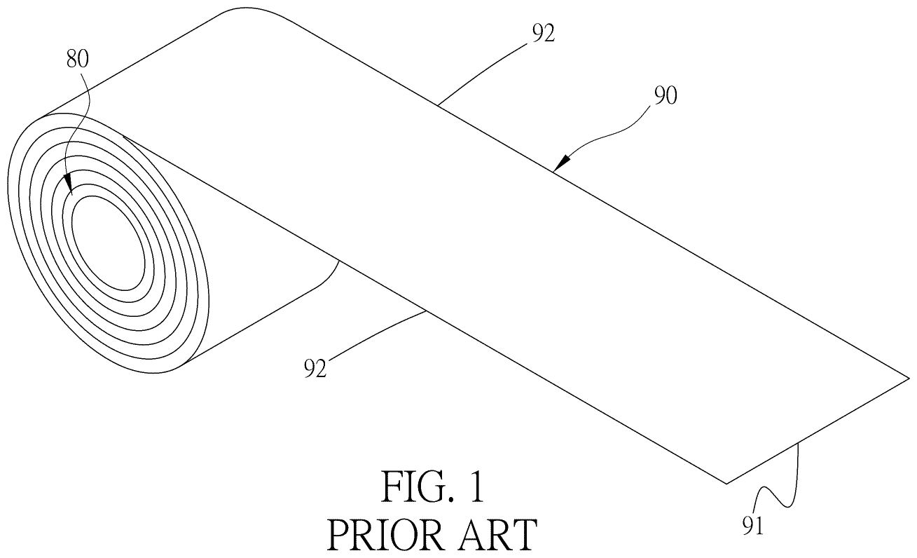

FIG. 2 is a side plan view showing the conventional tape being torn off.

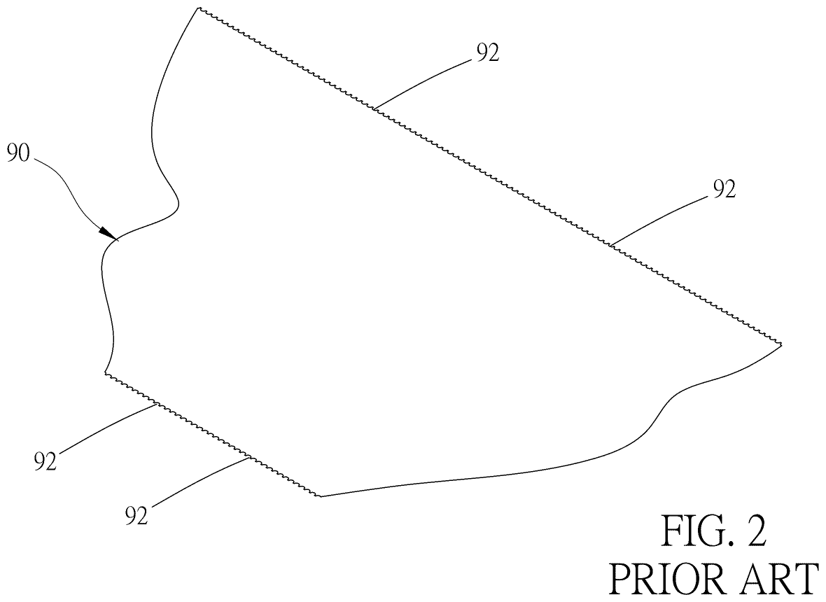

FIG. 3 is a perspective view showing the conventional tape being torn off.

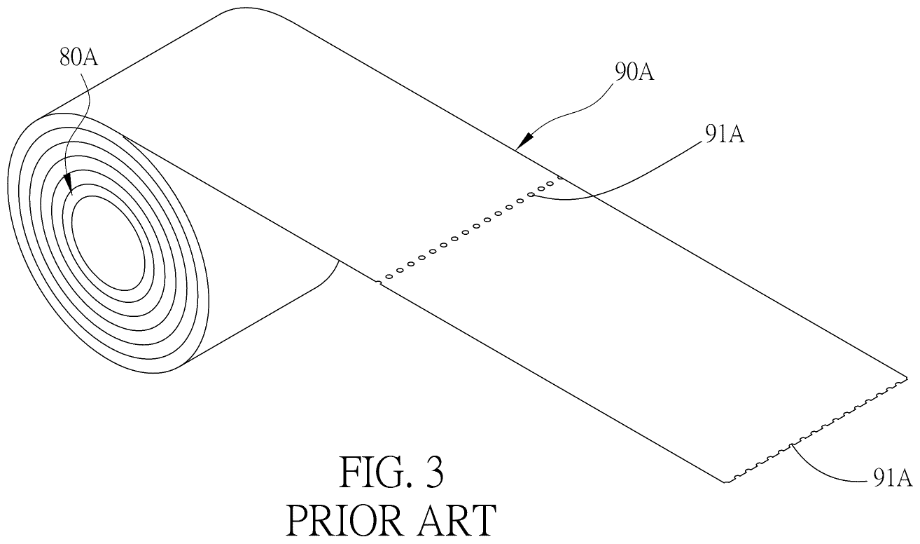

FIG. 4 is a cross-sectional perspective view showing the assembly of a part of straight edge cut easy hand tearing tapes according to a preferred embodiment of the present invention.

FIG. 5 is a perspective view showing the assembly of the straight-edge cuts easy hand tearing tapes according to the preferred embodiment of the present invention.

FIG. 6 is a cross-sectional view taken along the line A-A of FIG. 4.

FIG. 7 is a cross-sectional view taken along the line B-B of FIG. 4.

FIG. 8 is a perspective view showing the application of the straight-edge cut easy hand tearing tapes according to the preferred embodiment of the present invention.

FIG. 9 is another perspective view showing the application of the straight edge cut easy hand tearing tapes according to the preferred embodiment of the present invention.

FIG. 10 is a cross-sectional view showing the application of the straight edge cut easy hand tearing tapes according to the preferred embodiment of the present invention.

### DETAILED DESCRIPTION

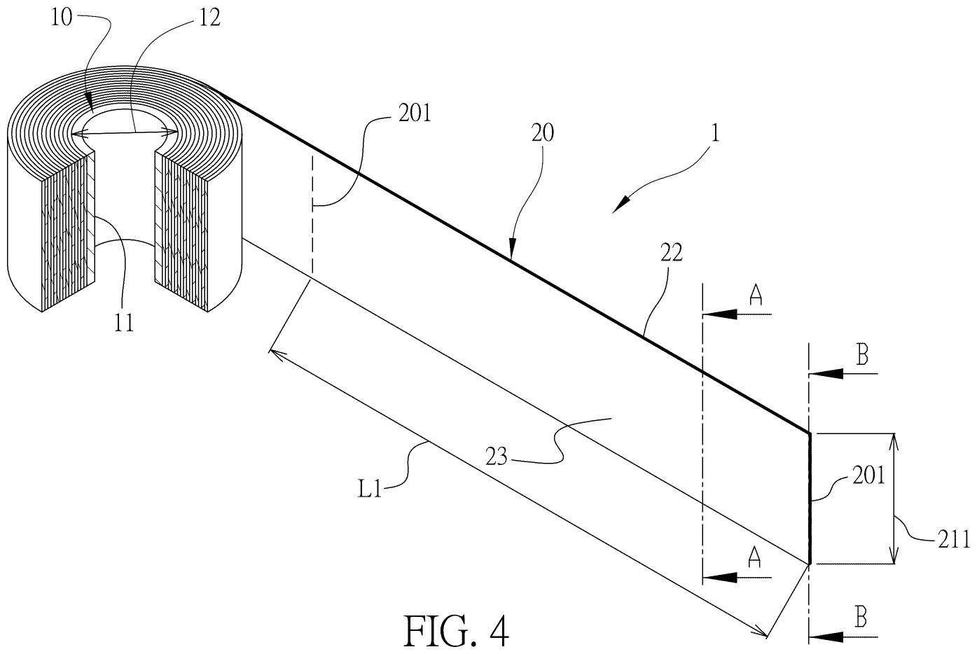

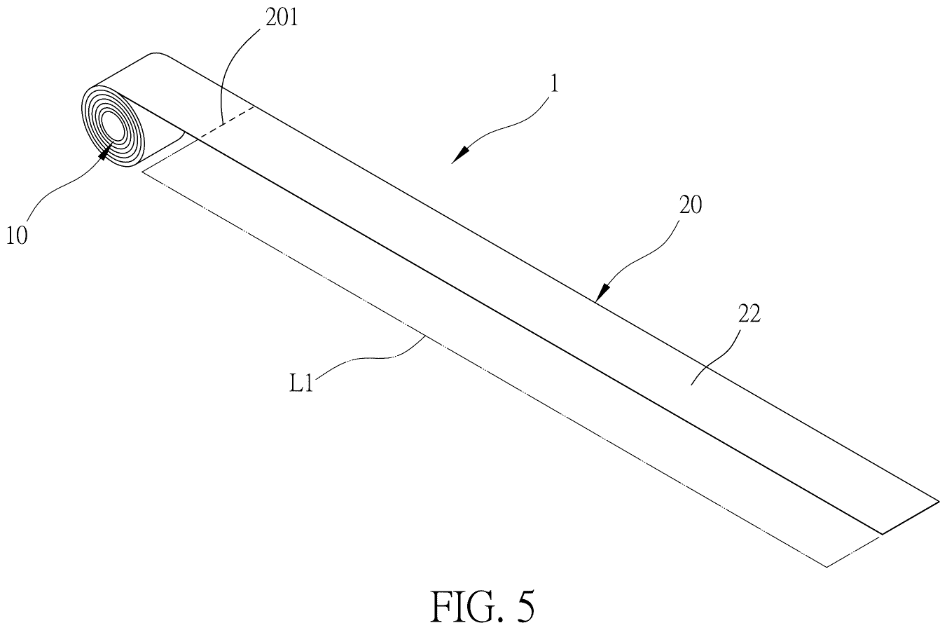

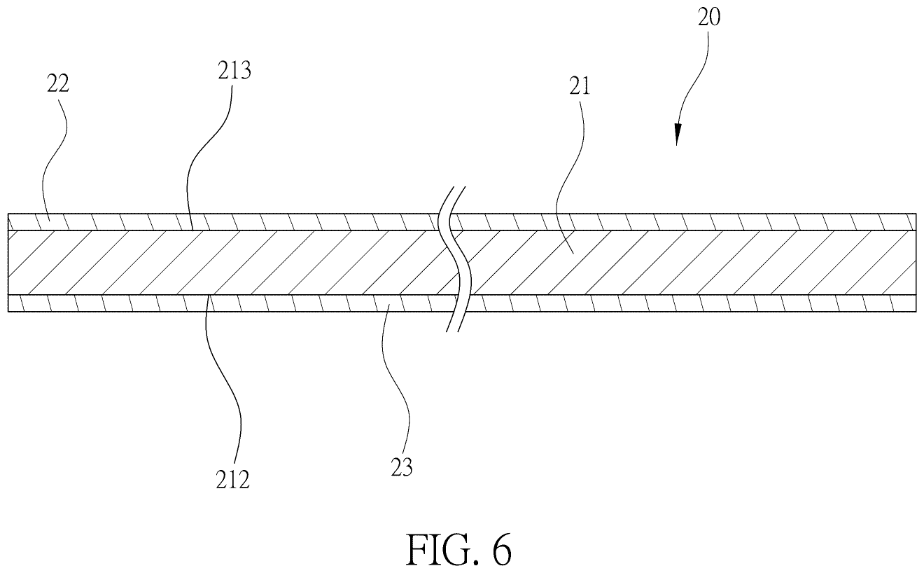

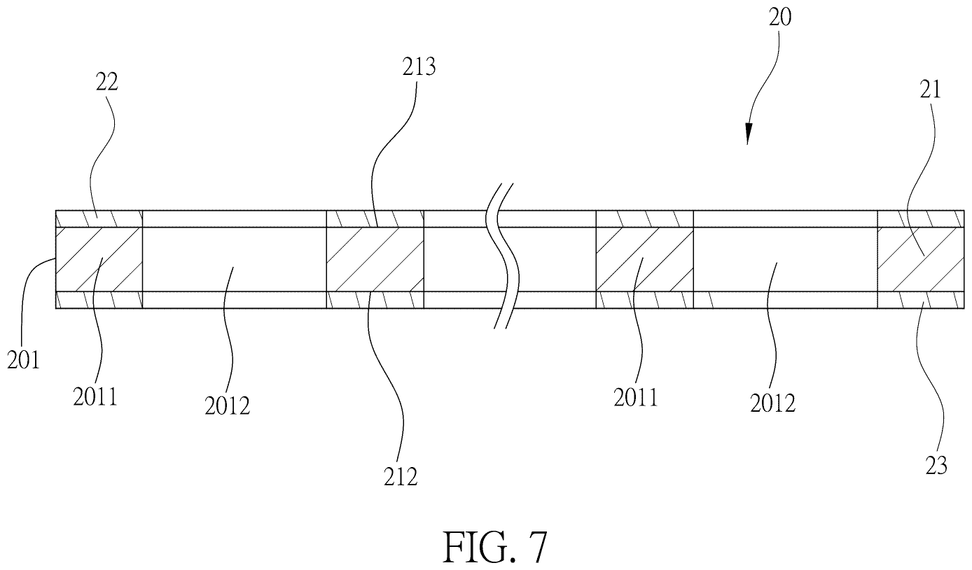

With reference to FIGS. 4-7, straight edge cut easy hand tearing tapes 1 according to a preferred embodiment of the present invention, each straight edge cut easy hand tearing tape 1 comprises a cylinder 10 and a tape strip 20 includes a tape body 21, a release layer 22, and an adhesion layer 23.

The cylinder 10 is hollowly annular and includes a predetermined width 11 and an external diameter 12.

The tape body 21 flatly extends, and the tape body 21 has a width 211 for matching with the predetermined width 11 of the cylinder 10, an internal face 212, and an external face 213 opposite to the internal face 212.

The release layer 22 has an equal thickness defined on the surface of the external face 213 and is configured to tear off an object on the external face 213 easily, wherein the release layer 22 is transparent or/and colored or/and has patterns.

The adhesion layer 23 has an equal thickness defined on the surface of the internal face 212 and is transparent or colored.

The tape strip 20 includes a predetermined length L1 and a linearly spaced portion 201 which is not a removal manner, wherein the linearly spaced portion 201 has a connection section 2011 and a separation section 2012 which are alternatively formed on the linearly spaced portion 201.

The tape strip 20 is rolled by using the adhesion layer 23 of the internal face 212 of the tape body 21 and is adhered on a peripheral wall of the cylinder 10, when the tape strip 20 is rolled in a circle, the adhesion layer 23 of the internal face 212 is adhered to the release layer 22 of the external face 213 of the tape strip 20 which is previously rolled, such that the tape strip 20 is rolled spirally, and a next circle of the adhesion layer 23 is adhered on the release layer 22 to be torn off completely.

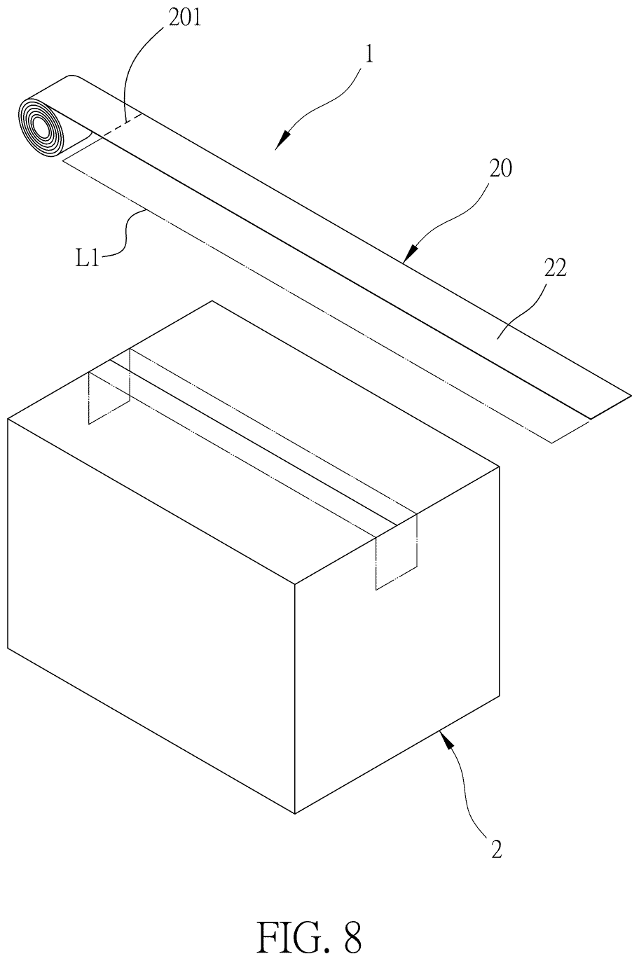

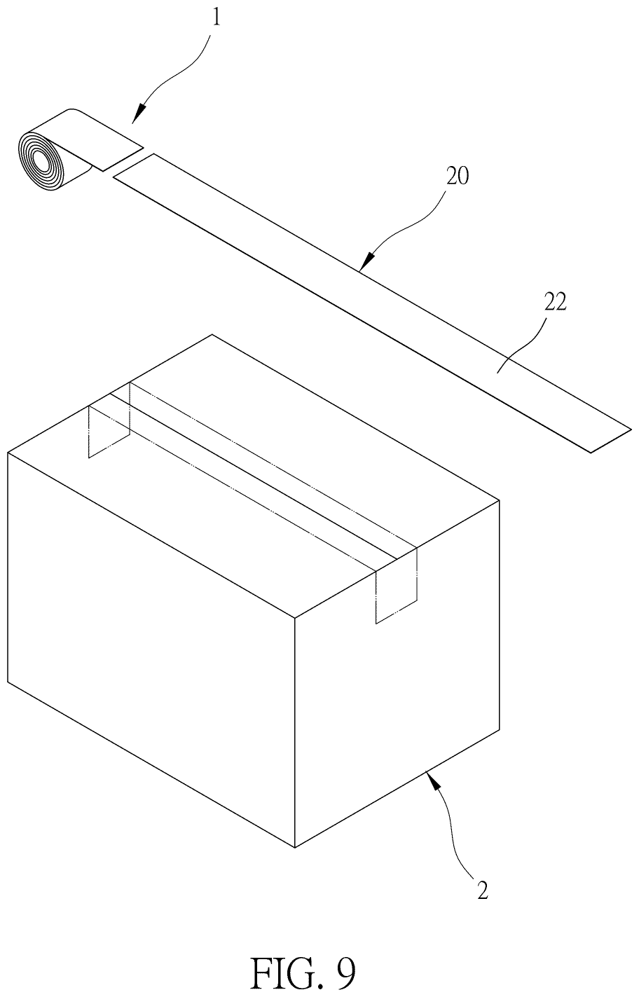

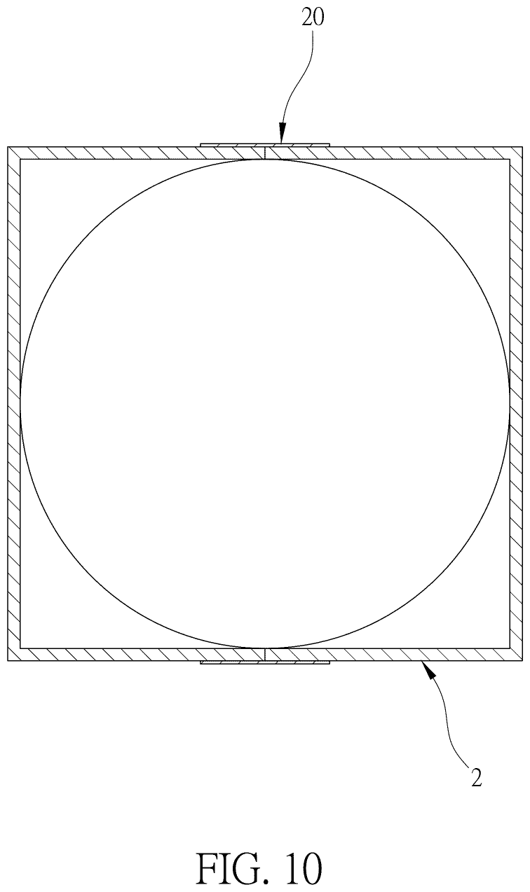

When each straight edge cut easy hand tearing tapes 1 is adhered on the object 22, as shown in FIGS. 8 and 9, the tape strip 20 is torn off and pulled outward by ways of a distal end of each straight edge cut easy hand tearing tapes 1, wherein when the linearly spaced portion 201 of the tape strip 20 is pulled, the linearly spaced portion 201 is broken automatically so that the adhesion layer 23 of the tape body 23 is adhered on the object 2, as illustrated in FIG. 10.

Accordingly, the straight edge cut easy hand tearing tapes 1 have following advantages:

The tape strip 20 of each straight edge cut easy hand tearing tape 1 includes the predetermined length L1 and the linearly spaced portion 201 which is not the removal manner so as to limit the length of the tape strip 20 without using a tape dispenser or a knife, hence the strength of the tape strip 20 is maintained and the tape strip 20 is applied conveniently and easily, and an aesthetics appearance and a flatness are achieved, after manually tearing the tape strip 20.

While the first embodiments of the invention have been set forth for the purpose of disclosure, modifications of the disclosed embodiments of the invention as well as other embodiments thereof may occur to those skilled in the art. The scope of the claims should not be limited by the first embodiments set forth in the examples, but should be given the broadest interpretation consistent with the description as a whole.

What is claimed is:

1. Straight edge cut easy hand tearing tapes, each straight edge cut easy hand tearing tape comprising a cylinder and a tape strip, and the tape strip including a tape body and an adhesion layer;
wherein the cylinder is hollowly annular and includes a predetermined width;
wherein the tape body flatly extends, and the tape body has a width for matching with the predetermined width of the cylinder, an internal face, and an external face opposite to the internal face;
wherein the adhesion layer has an equal thickness defined on the surface of the internal face;
wherein the tape strip includes a predetermined length and a linearly spaced portion which is not a removal manner, wherein the linearly spaced portion has a connection section and a separation section which are alternatively formed on the linearly spaced portion; and
wherein the tape strip is rolled by using the adhesion layer of the internal face of the tape body and is adhered to a peripheral wall of the cylinder, when the tape strip is rolled in at least one circle, the adhesion layer of the internal face is adhered on a release layer of the external face of the tape strip which is previously rolled, such that the tape strip is rolled spirally.

2. The straight edge cut easy hand tearing tapes as claimed in claim 1 further comprising a release layer which has an equal thickness defined on the surface of the external face of the tape body.

3. The straight edge cut easy hand tearing tapes as claimed in claim 1, wherein the adhesion layer is transparent or colored.

4. The straight edge cut easy hand tearing tapes as claimed in claim 2, wherein the release layer is transparent.
